(19) United States
(12) Patent Application Publication
(10) Pub. No.: US 2018/0219305 A1
(43) Pub. Date: Aug. 2, 2018

(54) HIGH POWER MODULE INTERFACES

(71) Applicant: Hamilton Sundstrand Corporation, Charlotte, NC (US)

(72) Inventors: Jeffrey T. Wavering, Rockford, IL (US); Kevin D. Kilroy, Rockford, IL (US); Stephen E. Jackson, Rockford, IL (US)

(21) Appl. No.: 15/417,857

(22) Filed: Jan. 27, 2017

(51) Int. Cl. H01R 4/48; H01R 13/11

(52) U.S. Cl. CPC H01R 4/4809; H01R 13/112

(57) ABSTRACT

A high power module interface system, can include a blade contact configured to be mounted to a circuit board and a mounting fork having a conductive body including a first fork extension and a second fork extension defining a power interface feature opening therebetween. The mounting fork can be configured to provide electrical connection between the conductive body and the blade contact when the blade contact is positioned within the power interface opening.

### BACKGROUND

### 1. Field

The present disclosure relates to electrical interfaces, more specifically to high power module interfaces (e.g., for line replaceable modules).

### 2. Description of Related Art

In the aerospace industry, power distribution connectors generally go up to about 50 Amp ratings with No. 8 gauge contacts. These connectors are used on line replaceable modules (LRMs) or distribution of Thermal Circuit Breaker (TCB) protected wiring interfaces. As the industry moves to more electric aircraft architectures, power levels required for distribution have gone up along with operating voltages.

The distribution switch technologies have also changed with solid state switches using SiC technologies that support higher current switches that exceed 50 Amps. Traditional systems and connectors cannot provide an efficient electrical power interface to large power, high voltage, distribution LRMs and are also difficult to replace if needed.

Such conventional methods and systems have generally been considered satisfactory for their intended purpose. However, there is still a need in the art for improved high power module interfaces. The present disclosure provides a solution for this need.

### SUMMARY

A high power module interface system, can include a blade contact configured to be mounted to a circuit board and a mounting fork having a conductive fork body including a first fork extension and a second fork extension defining a power interface opening there between. The mounting fork can be configured to provide electrical connection between the conductive body and the blade contact when the blade contact is positioned within the power interface opening.

The mounting fork can include a power conducting interface feature disposed within the power interface opening between the first and second fork extensions to provide the electrical connection. The power interface feature can allow for greater misalignment between the blade contact and the mounting fork and other multiple blade and mounting forks on the same module without detrimental effects of the electrical connection than would be allowed if the power interface feature were not present.

The power conducting interface feature can include one or more spring foils. The spring foils can resiliently provide loads between the blade contact and the first fork extension and the second fork extension. In certain embodiments, when the blade contact is inserted into the power interface opening, the one or more spring foils is flattened between the blade contact and a wall of at least one of the first fork extension and the second fork extension.

The conductive fork body can be configured, e.g., with interface features, to allow and support electrical contact with a bus bar. The conductive fork body can be configured to mount to a non-conductive chassis mount to keep it electrically isolated. The high power module interface system can be capable of reliably conducting at least 50 amps between the blade contact and the mounting fork, e.g., by appropriately selecting the width of the blade and the fork (e.g., without damage to the mounting fork or the blade contact).

In certain embodiments, a width of the opening at the interface foil when not in operable communication with the blade contact is smaller than a width of the blade contact. The mounting fork can be configured to allow the width of the interface foil opening to resiliently increase when the blade contact is positioned between the first fork extension and the second fork extension.

The mounting fork can include one or more fastener holes to receive a bus bar fastener. The blade contact can include a flat shaped contact end (e.g., with a smoothed tip) and a mounting end.

These and other features of the systems and methods of the subject disclosure will become more readily apparent to those skilled in the art from the following detailed description taken in conjunction with the drawings.

### BRIEF DESCRIPTION OF THE DRAWINGS

So that those skilled in the art to which the subject disclosure appertains will readily understand how to make and use the devices and methods of the subject disclosure without undue experimentation, embodiments thereof will be described in detail herein below with reference to certain figures, wherein:

FIG. 1 is a plan view of an embodiment of a system in accordance with this disclosure;

FIG. 2 is a side view of the embodiment of FIG. 1;

FIG. 3 is a perspective view of an embodiment of a mounting fork in accordance with this disclosure;

FIG. 4 is a perspective view of an embodiment of a blade contact in accordance with this disclosure;

FIG. 5A is a perspective view of a portion of the embodiment of FIG. 1, showing the blade contact removed from the mounting fork;

FIG. 5B is a perspective and side view of the embodiment of FIG. 1, showing each blade contact removed from each mounting fork;

FIG. 6A is a perspective view of a portion of the embodiment of FIG. 1, showing the blade contact disposed in the mounting fork;

FIG. 6B is a perspective and side view of the embodiment of FIG. 1, showing each blade contact disposed in each mounting fork;

FIG. 7A is a perspective view of an embodiment of a mounting fork in accordance with this disclosure; and

FIG. 7B is a perspective view of the embodiment of FIG. 7A, showing an embodiment of the blade contact disposed in the mounting fork.

### DETAILED DESCRIPTION

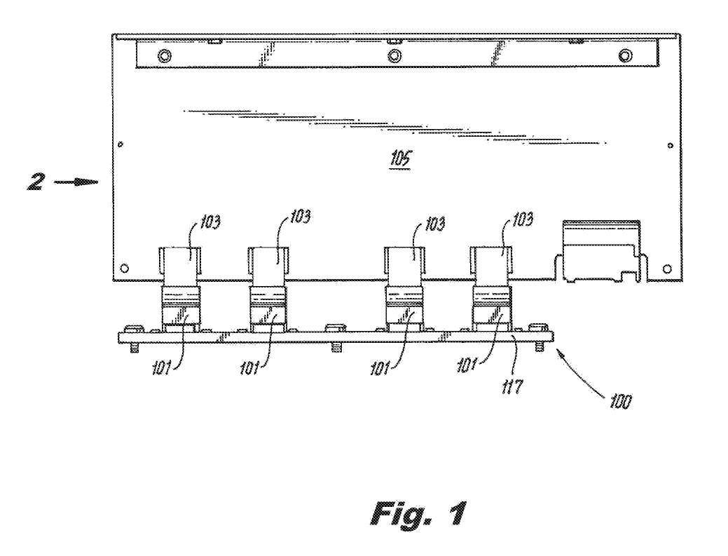

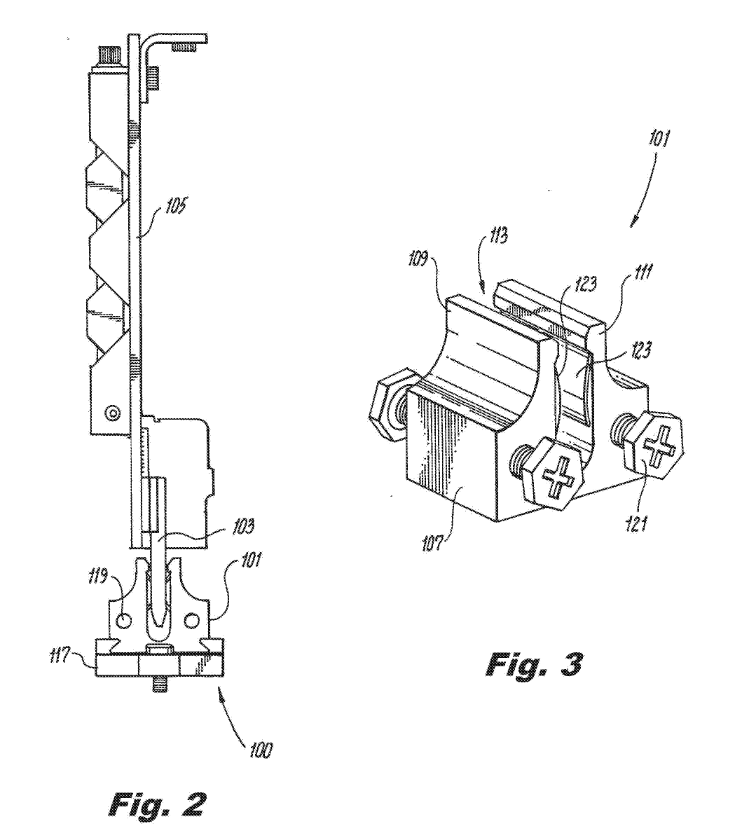

Reference will now be made to the drawings wherein like reference numerals identify similar structural features or aspects of the subject disclosure. For purposes of explanation and illustration, and not limitation, an illustrative view of an embodiment of a system in accordance with the disclosure is shown in FIG. 1 and is designated generally by reference character 100. Other embodiments and/or aspects of this disclosure are shown in FIGS. 2-6B. The systems and methods described herein can be used to provide robust, easily connectable and detachable interfaces for high power modules (e.g., certain line replaceable modules).

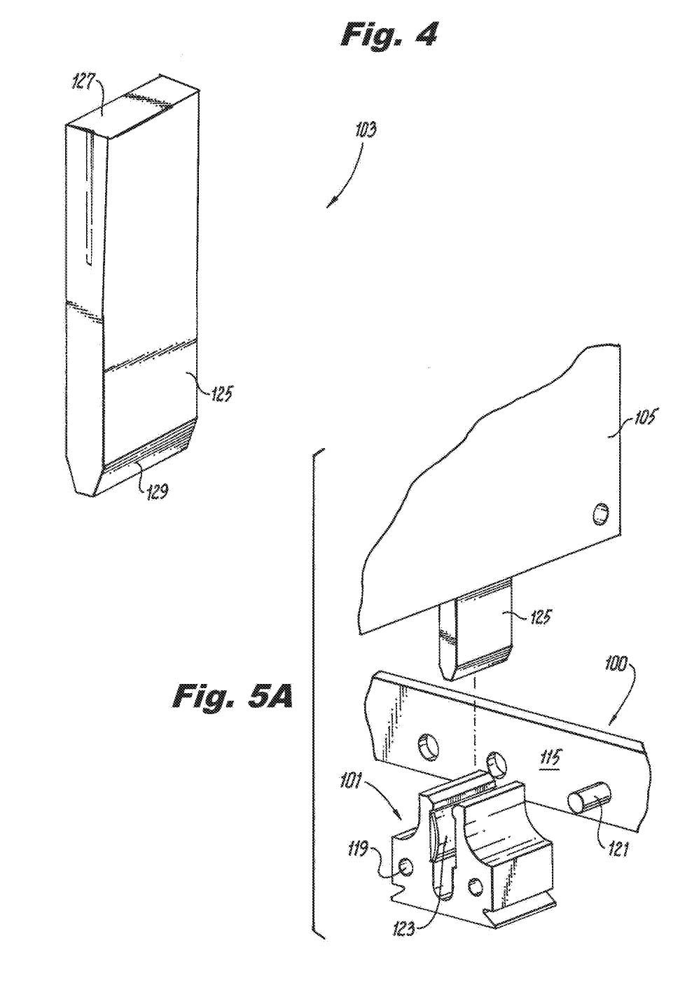

Referring to FIGS. 1 and 2, a high power module interface system 100 can include a mounting fork 101 and a blade contact 103 configured to be mounted to a circuit board 105. Referring additionally to FIG. 3, the mounting fork 101 for a high power interface can include a conductive body 107 including a first fork extension 109 and a second fork extension 111 defining a power interface opening 113 therebetween. The fork extensions 109, 111 can include any suitable shape and dimensions (e.g., thinning as a function of extension). The mounting fork 101 is configured to receive the blade contact 103 of a circuit board 105 and to provide an electrical connection (e.g., and possibly a retaining force) to the blade contact 103.

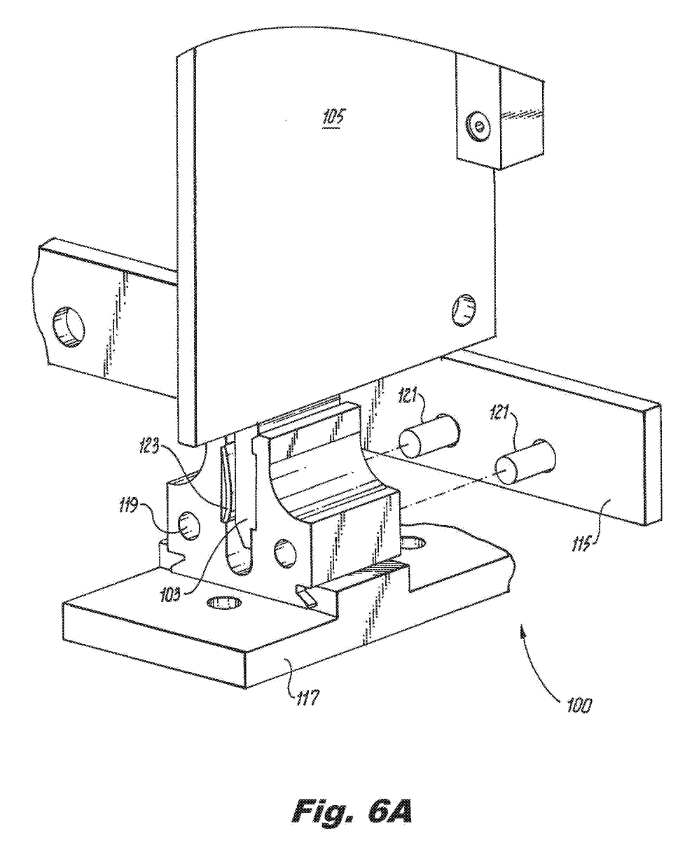

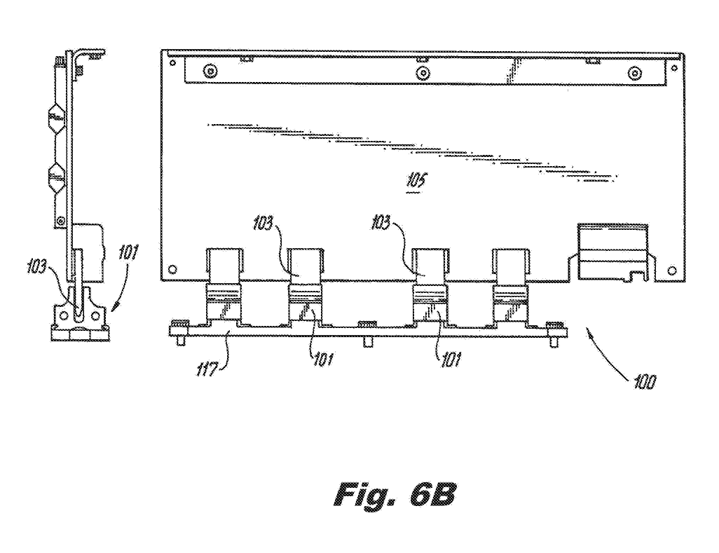

The conductive body 107 can be configured to mount to and be in electrical communication with a bus bar 115 (e.g., as shown in FIGS. 5A and 6A). In certain embodiments, the mounting fork 101 can include one or more fastener holes 119 (e.g., as shown in FIG. 2) that are configured to receive a bus bar fastener 121. The mounting fork 101 can be scaled to any suitable size for a predetermined power need (e.g., 50 Amps or more) to prevent damage to the mounting fork 101.

The conductive body 107 can also be configured to mount to a non-conductive chassis mount 117. For example, as shown in FIG. 2, the mounting fork 101 can include a mating shape to be inserted into the chassis mount 117 and be retained by the chassis mount 117 in at least one direction. In certain embodiments, the system 100 can include the non-conductive chassis 117 and/or the bus bar 115.

Referring again to FIG. 3, the mounting fork 101 can include a conductive interface feature 123 disposed within the power interface opening 113 between the first and second fork extensions 109, 111 to provide the electrical connection (and the retaining force) with the blade contact 103. In certain embodiments, the retaining feature 123 can include one or more (e.g., a pair) spring foils. The spring foils can resiliently provide loads between the blade contact 103 and the first fork extension 109 and the second fork extension 111. In certain embodiments, when the blade contact 103 is inserted into the power interface opening 113, the one or more spring foils can be flattened between the blade contact 103 and a wall of at least one of the first fork extension 109 and the second fork extension 111.

In this regard, the first and second fork extensions 109, 111 can include a suitable detent to receive the spring foilss or any other suitable retaining feature. Any suitable retaining feature 123 of any suitable size, shape, or other dimension is contemplated herein and can be sized to have any suitable height, width configured to handle any suitable current. The retaining feature 123 can allow for greater misalignment between the blade contact 103 and the mounting fork 101 without detrimental effects of the electrical connection than would be allowed if the retaining feature 123 were not present.

A width of the power interface opening at the spring foil 123 when not in operable communication with the blade contact 103 can be smaller than a width of the blade contact 103. The thickness of the spring foil in the fork extensions 109, 111, can be varied to change the flexibility of the electrical conductive interface and change the amount of current carrying capability. Any reduction in current carrying capability can be compensated with increased lateral width of the fork extensions 109, 111 if desired.

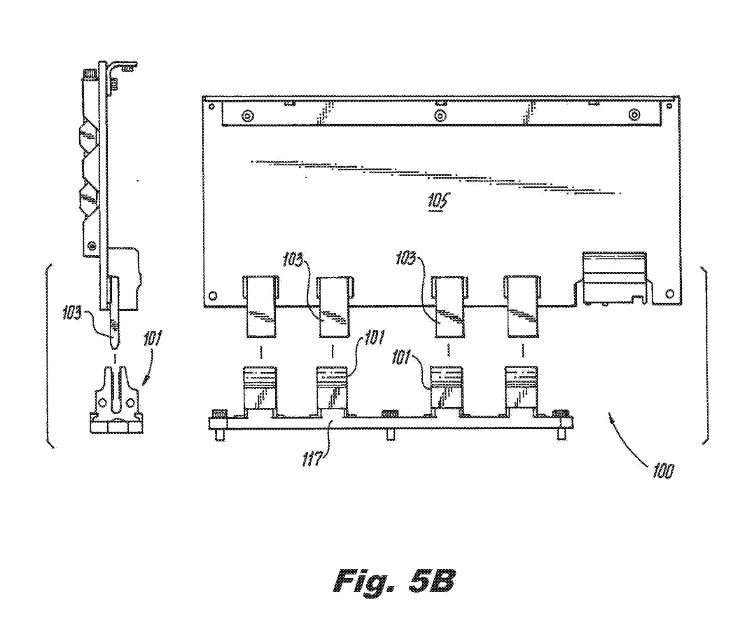

Referring to FIG. 4, the blade contact 103 can include a flat shaped contact end 125 and a mounting end 127. The flat shaped contact end 125 can include a chamfered, fileted, or otherwise smoothed tip 129 for guiding the flat shaped contact end 125 into the power interface opening 113. The blade contact 103 can be sized to have thickness and/or any other dimensions to handle any suitable predetermined power. For example, the high power module interface system 100 can be capable of reliably conducting at least 50 amps between the blade contact 103 and the mounting fork 101 (e.g., without damage to the mounting fork or the blade contact). The mounting end 127 can include any suitable structure to be connected to the circuit board 105.

The system 100 can include the circuit board 105. In such embodiments, the blade contact 103 can be mounted to the circuit board 105 in any suitable manner. In certain embodiments, the circuit board 105 can be a line replaceable module (LRM) or any other suitable device. Any suitable number (e.g., four as shown) of blade contacts 103 can be implemented on a given circuit board 105 and can each be connected to a bus bar 115.

Generally, traditional power interfaces use a nut and bolt to make connection sufficient to accept high power (e.g., up to 50 Amps), but such structures inhibit replacement of the modules. Referring to FIGS. 5A, 5B, 6A, and 6B, a module can be inserted and electrically connected to the bus bar 115 by pushing the blade contacts 103 into each mounting fork 101. The module can then be removal when desired without disconnecting any nuts, bolts, or other fasteners.

As described above, the mounting forks 101 can be bolted to a bus bar 115, which is connected to power supply. The electrical signal goes from bus bar 115 to each mounting fork 101 to the circuit board 105. The non-conductive chassis mount 117 attaches to the chassis and prevents electrical current from traveling to the chassis. The mounting forks 101 can be attached to the non-conductive chassis mount 117 and can be sized to allow for tolerance variation between each power blade 103.

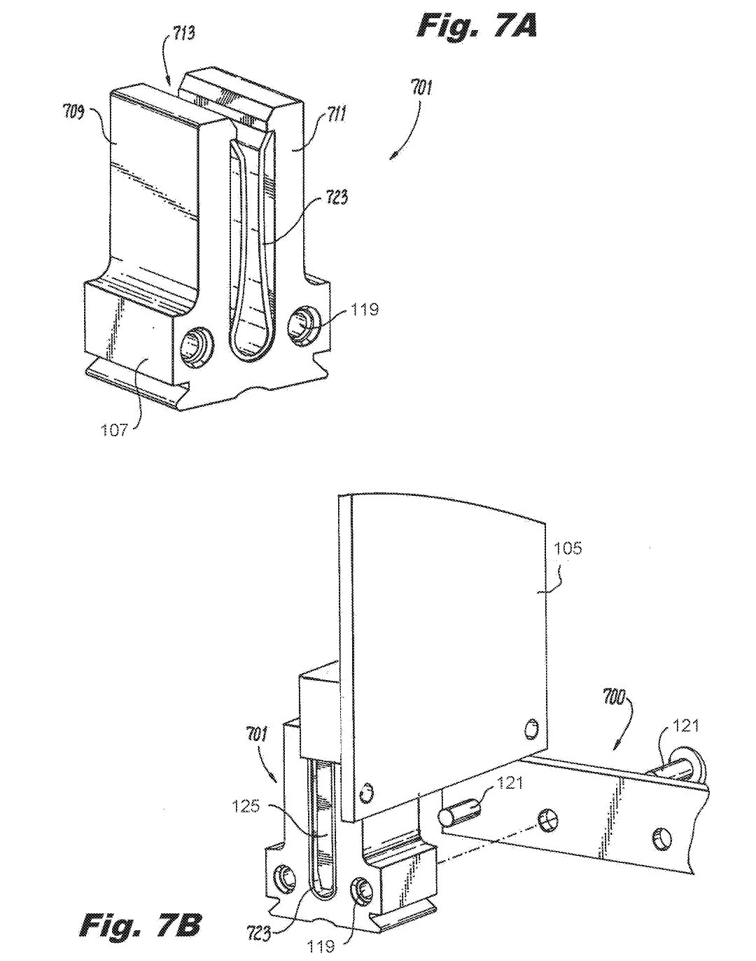

Referring to FIG. 7A, another embodiment of a mounting fork 701 is shown. The embodiment of FIG. 7A includes fork extensions 709, 711 extending from body 107. As shown the fork extensions 709, 711 can be relatively longer than the fork extensions 109, 111 of mounting fork 101. The fork extensions 709, 711 can define power interface opening 713 which can also include a retaining feature 723. As shown, in certain embodiments, the retaining feature 723 can be a single piece (e.g., of metal).

FIG. 7B shows the mounting fork 701 in use with a system 700. System 700 includes similar features as described above with respect to system 100.

Embodiments provide the ability to move a large amount of current on and off an LRM or other suitable circuit in a relatively small volume. Embodiments can support a two switch LRM of high voltage DC at currents of 75A and up, for example. Two additional blades could be added to support a 3 Phase AC switch module with currents 75A and up for example. Embodiments allow an efficient power transfer to and from a solid state switch module in a relatively small space while supporting needed dielectric spacing and managing the many tolerances to not load or stress any one interface. To have suitable electrical connection, contact between the blade and the fork can be maintained and maximized, and any resulting retaining force can be a secondary benefit. However, limited or no retaining force is contemplated herein as long as an electrical connection is established.

The methods and systems of the present disclosure, as described above and shown in the drawings, provide for interfaces and related systems with superior properties. While the apparatus and methods of the subject disclosure have been shown and described with reference to embodiments, those skilled in the art will readily appreciate that changes and/or modifications may be made thereto without departing from the spirit and scope of the subject disclosure.

1. A mounting fork for a high power interface, comprising:
a conductive body including a first fork extension and a second fork extension defining a power interface opening therebetween, the mounting fork being configured to provide electrical connection between the conductive body and a blade contact of a circuit board positionable within the power interface opening, wherein conductive body is rigid and is configured to be mounted to a bus bar such that the conductive body does not move relative to the bus bar.

2. The mounting fork of claim 1, further comprising a power interface feature disposed within the power interface opening between the first and second fork extensions to provide the electrical connection.

3. The mounting fork of claim 2, wherein the power interface feature includes one or more spring foil.

4. The mounting fork of claim 3, wherein when the blade contact is inserted into the power interface opening, the one or more spring foil is flattened between the blade contact and a wall of at least one of the first fork extension and the second fork extension.

5. A high power module interface system, comprising:
a blade contact configured to be mounted to a circuit board, and
a mounting fork having a conductive body including a first fork extension and a second fork extension defining a power interface opening therebetween,
the mounting fork being configured to provide electrical connection between the conductive body and the blade contact when the blade contact is positioned within the power interface opening, wherein conductive body is rigid and is configured to be mounted to a bus bar such that the conductive body does not move relative to the bus bar.

6. The system of claim 5, wherein the conductive body is configured to mount to and be in electrical contact with a bus bar, and wherein the conductive body is configured to mount to a non-conductive chassis mount.

7. The system of claim 5, further comprising a power interface feature disposed within the power interface opening between the first and second fork extensions to provide the electrical connection.

8. The system of claim 7, wherein the power interface feature includes one or more spring foil that resiliently provide loads between the blade contact and the first fork extension and the second fork extension.

9. The system of claim 8, wherein the power interface feature allows for greater misalignment between the blade contact and the mounting fork without detrimental effects of the electrical connection than would be allowed if the power interface feature were not present.

10. The system of claim 5, wherein the high power module interface system is capable of reliably conducting at least 50 amps between the blade contact and the mounting fork.

11. The system of claim 5, wherein a width of the power interface feature opening when not in operable communication with the blade contact is smaller than a width of the blade contact, the mounting fork being configured to allow the width of the power interface feature opening to resiliently increase when the blade contact is positioned between the first fork extension and the second fork extension.

12. The system of claim 5, comprising wherein the mounting fork includes one or more fastener holes to receive a bus bar fastener.

13. The system of claim 6, further comprising the non-conductive chassis and/or the bus bar.

14. The system of claim 7, wherein the blade contact includes a flat shaped contact end and a mounting end.
